(19) United States
(12) Patent Application Publication
(10) Pub. No.: US 2020/0343560 A1
(43) Pub. Date: Oct. 29, 2020

(54) SECONDARY BATTERY ELECTRODE, METHOD FOR MANUFACTURING SAME, AND SECONDARY BATTERY

(71) Applicant: HONDA MOTOR CO., LTD., Tokyo (JP)

(72) Inventors: Masahiro Ohta, Wako-shi (JP); Wataru Shimizu, Wako-shi (JP); Toru Sukigara, Wako-shi (JP)

(21) Appl. No.: 16/851,139

(22) Filed: Apr. 17, 2020

(30) Foreign Application Priority Data
Apr. 25, 2019 (JP) 2019-083904

(51) Int. Cl. H01M 4/76; H01M 4/04

(52) U.S. Cl. CPC H01M 4/762; H01M 2004/021; H01M 4/0416; H01M 4/043

(57) ABSTRACT

A secondary battery electrode 100 of the present invention includes: a plurality of metallic porous plates 101 superposed in a thickness direction T; and an electrode mixture 102 with which voids constituting the metallic porous plates 101 are filled, in which adjacent metallic porous plates 101 are press-jointed to each other.

### BACKGROUND OF THE INVENTION

### Field of the Invention

The present invention relates to a secondary battery electrode, a method for manufacturing the same, and a secondary battery.

Priority is claimed on Japanese Patent Application No. 2019-083904, filed Apr. 25, 2019, the content of which is incorporated herein by reference.

### Description of Related Art

Since a secondary battery such as a lithium ion battery has a high energy density and charging and discharging can be repeated with the secondary battery, secondary batteries are applied in various technical fields such as in small portable devices and electric vehicles. A secondary battery exchanges ions between a positive electrode and a negative electrode through an electrolyte. Since the electrolyte of secondary batteries that have become widespread is a liquid, devices for preventing liquid leakage are required, and reduction in the degree of freedom in design has become a challenge. In light of this challenge, in recent years, all-solid batteries in which the electrolyte is made of a solid material have been attracting attention.

All-solid batteries have both higher energy density and safety than secondary batteries in which a liquid electrolyte is used, and it is expected that all-solid batteries will be put to practical use at an early stage. An electrode of an all-solid battery is formed by applying an electrode mixture slurry consisting of an electrode active material, a solid electrolyte, a conductive assistant, and a binder on a current-collecting metal foil and drying the slurry (Patent Document 1). The presence of a binder is indispensable to maintain the strength of a solid electrolyte, and a material having various compositions has been proposed as a binder material (Patent Document 2).

### PATENT DOCUMENTS

[Patent Document 1] Japanese Patent No. 5975072

[Patent Document 2] Japanese Unexamined Patent Application, First Publication No. 2016-25027

### SUMMARY OF THE INVENTION

There is a demand for further improvement in the energy density of a secondary battery mounted on an electronic device accompanying the miniaturization and thinning of electronic devices in recent years. Thickening of an electrode mixture has been proposed as an attempt for improving the energy density. However, in the case of thickening an electrode mixture, it is necessary to increase the content of binder to maintain the strength of the electrode mixture, which causes increase in electrical resistance and decrease in output of a secondary battery. In addition, in the case of thickening an electrode mixture, a portion where the distance from the current-collecting foil becomes longer is generated, and the increase in electrical resistance in this portion also exerts an influence on the decrease in output of a secondary battery.

The present invention has been made from the viewpoint of the above-described circumstances, and an object of the present invention is to provide a secondary battery electrode which realizes a secondary battery with an improved energy density while decrease in output is minimized.

In order to solve the above-described problem, the present invention employs the following means.

(1) A secondary battery electrode according to an aspect of the present invention includes: a plurality of metallic porous plates superposed in a thickness direction; and an electrode mixture with which voids constituting the metallic porous plates are filled, in which adjacent metallic porous plates are press-joined to each other.

(2) In the secondary battery electrode according to (1), it is preferable that a porosity of the electrode mixture used for filling be less than or equal to 5%.

(3) In the secondary battery electrode according to any one of (1) or (2), it is preferable that the metallic porous plates be of a foamed metal.

(4) In the secondary battery electrode according to any one of (1) to (3), it is preferable that end portions protruding outward from a surface of the electrode mixture used for filling be provided on a surface of the metallic porous plate.

(5) In the secondary battery electrode according to any one of (1) to (4), it is preferable that a protective film be formed at both ends in the direction in which the plurality of metallic porous plates are superposed.

(6) In the secondary battery electrode according to any one of (1) to (5), it is preferable that the protective film on a positive electrode side be made of a substance containing at least one of a positive electrode active material and a solid electrolyte.

(7) In the secondary battery electrode according to any one of (1) to (6), it is preferable that the protective film on a negative electrode side be made of a substance containing at least one of a negative electrode active material and a solid electrolyte.

(8) In the secondary battery electrode according to any one of (1) to (7), it is preferable that a standard deviation of a filling rate of the electrode mixture in a direction parallel to a main surface of the metallic porous plate be less than or equal to 10%.

(9) A method for manufacturing a secondary battery electrode according to an aspect of the present invention is a method for manufacturing the secondary battery electrode according to any one of (1) to (8) and includes: a step of filling voids of a plurality of metallic porous plates with an electrode mixture; and a step of pressing the plurality of metallic porous plates in a superposition direction in a state where the plurality of metallic porous plates are superposed in a thickness direction.

(10) It is preferable that the method for manufacturing the secondary battery electrode according to (9) further include: a step of individually pressing the plurality of metallic porous plates filled with the electrode mixture in the thickness direction before the metallic porous plates are superposed.

(11) A secondary battery according to an aspect of the present invention includes: the secondary battery electrode according to any one of (1) to (8) as a positive electrode and a negative electrode; and a stacked body obtained by stacking the positive electrode, an electrolyte layer or a separator layer, and the negative electrode in this order.

In the secondary battery electrode of the present invention, an electrode mixture (electrode mixture phase) is formed in a state in which holes constituting a metallic porous plate are filled with the electrode mixture, and supported by inner walls of the holes to maintain the strength. For this reason, even in the case where metallic porous plates are superposed to form an electrode mixture thick, it is unnecessary to increase the content of binder to maintain the strength, and increase in electrical resistance due to the binder can be minimized.

In addition, in the case where the metallic porous plates are superposed, current-collecting units are spread and distributed in a thickness direction of the electrode mixture. Therefore, even in the case where a thick electrode mixture is formed, a portion of the electrode mixture where the distances from the current-collecting units become longer can be reduced. Therefore, increase in electrical resistance depending on distance can be minimized.

Accordingly, according to the secondary battery electrode of the present invention, by forming a thick electrode mixture, it is possible to increase an energy density and avoid the problem of decrease in output when the secondary battery electrode is applied to a secondary battery.

### BRIEF DESCRIPTION OF THE DRAWINGS

FIG. 1A is a side view of a secondary battery electrode according to an embodiment of the present invention.

FIG. 1B is an exploded view of the secondary battery electrode according to the embodiment of the present invention.

FIG. 2 is an enlarged view of a part of a cross section of the secondary battery electrode of FIG. 1A.

FIG. 3 is a view showing a modification example of the secondary battery electrode of FIG. 1A.

(a) to (c) of FIG. 4 are cross-sectional views of objects to be treated in a process of manufacturing the secondary battery electrode of FIG. 1.

FIG. 5 is a cross-sectional view of a secondary battery including the secondary battery electrode according to the embodiment of the present invention.

### DETAILED DESCRIPTION OF THE INVENTION

Hereinafter, a secondary battery electrode according to an embodiment to which the present invention is applied, and a method for manufacturing the same will be described in detail with reference to the drawings. In the drawings used in the following description, a part that becomes a feature is sometimes enlarged for convenience in order to allow the feature to be easily understood, and the dimensional ratios of each constituent element or the like are not necessarily the same as the actual ones. In addition, the materials, dimensions, and the like exemplified in the following description are merely examples, and the present invention is not limited thereto and can be implemented by being appropriately modified within the range that does not change the gist thereof.

### First Embodiment

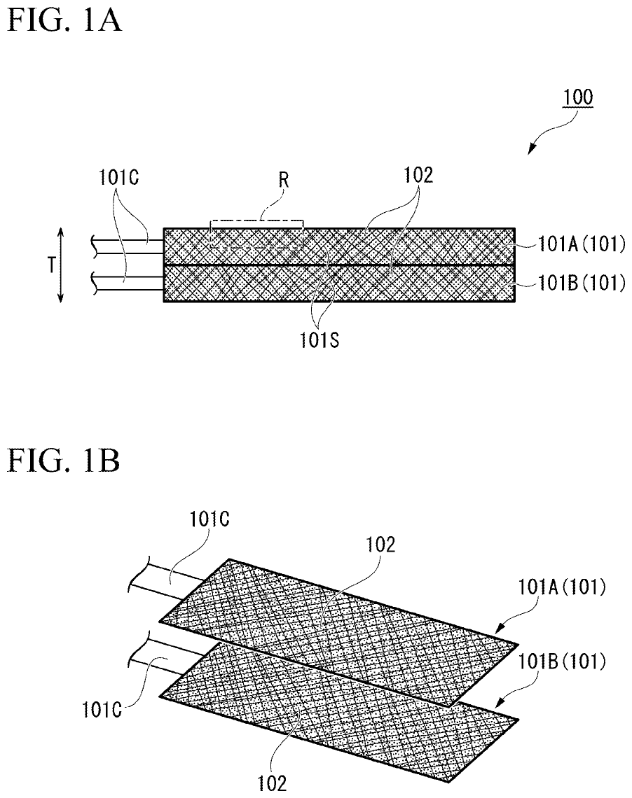

FIG. 1A is a side view of a secondary battery electrode 100 according to a first embodiment of the present invention.

The secondary battery electrode 100 includes: a plurality of metallic porous plates 101 superposed in a thickness direction T; and an electrode mixture 102 with which voids 101S constituting the metallic porous plates 101 are filled. Here, a case where two metallic porous plates 101A and 101B are superposed is exemplified. FIG. 1B is a view in which two superposed metallic porous plates 101 filled with the electrode mixture 102 are respectively disassembled.

The metallic porous plates 101 are of metal or are alloy members (such as foamed metal) having a large number of voids 101S therein, and have a plate-like outline. Examples of well-known materials constituting the metallic porous plates 101 include aluminum, stainless steel, nickel, iron, copper, silver, palladium, gold, and platinum.

In a case where a liquid electrolyte is used, the voids 101S become paths through which ions are conducted, and therefore, have a shape allowing communication between a main surface of at least one metallic porous plate and a main surface of the other metallic porous plate. The shape for the communication may be a random shape such as in air bubbles of a foamed metal, but any shape close to a straight line is preferable because in this case ions are easily conducted therethrough. In a case where a solid electrolyte is used, ions are conducted in the electrolyte. Therefore, the voids 101S are useless spaces from the viewpoint of conducting ions, and the porosity is preferably low. It is preferable that the porosity of a metallic porous plate be greater than or equal to 80% from the viewpoint of increasing the filling rate of a mixture, and less than or equal to 98% from the viewpoint of maintaining the strength of a metallic porous plate. The porosity of the electrode mixture 102 used for filling is preferably less than or equal to 5%.

The shapes of the main surfaces of the superposed metallic porous plates 101A and 101B may be uniform, but the shapes thereof are not limited. However, the thickness of the metallic porous plates 101 is preferably 0.05 mm to 1 mm. The thickness thereof being less than 0.05 mm is not preferable because the holding power of the electrode mixture 102 with which the metallic porous plates are filled becomes insufficient and the electrode mixture used for filling is likely to crack. In addition, the thickness thereof being greater than 1 mm is not preferable because the distribution of the electrode mixture 102 during press-joining is likely to become uneven.

Electrode lead-out portions 101C for connecting to an external power source are provided on side surfaces of the metallic porous plates 101. Since the plurality of metallic porous plates 101 are electrically connected to each other through press-joining, the electrode lead-out portions 101C may be provided in at least one metallic porous plate 101, but are preferably respectively provided in the metallic porous plates 101 from the viewpoint of the lead-out efficiency.

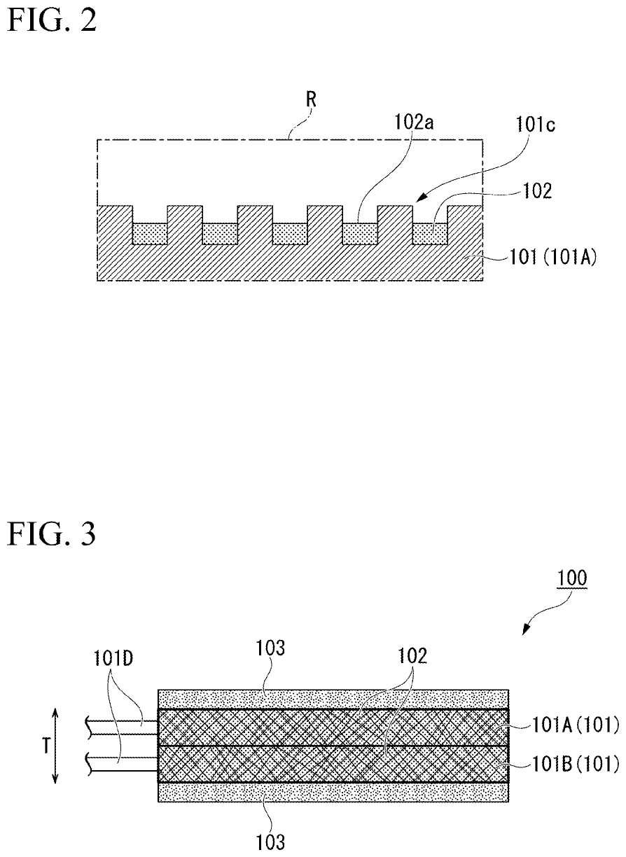

FIG. 2 is an enlarged view of a part R of a side surface of a metallic porous plate 101A of FIG. 1A. End portions 101c protruding outward (here, upward) from a surface 102a of the electrode mixture used for filling are provided on a surface of the metallic porous plate 101. More specifically, convex portions having a height of about 0.01 to 0.05 mm are arranged along the surface of the metallic porous plate 101. The surface of the other part not shown here also has the same structure. Although a case where the protruding end portions 101c are regularly arranged is exemplified here, in many cases, these are randomly arranged in reality. Such protruding end portions 101c may be provided when joining metallic porous plates connected to the same electrode. However, such end portions in joining in which different electrodes face each other across a solid electrolyte layer may cause a short circuit, and therefore, the surface is preferably smoothed through pressing or the like.

Among the plurality of superposed metallic porous plates 101, adjacent metallic porous plates 101 (metallic porous plates 101A and 101B in FIGS. 1A and 1B) are press-joined to each other in the superposition direction (thickness direction T). By this press-joining, the end portions 101c constituting the joining surfaces of the joined metallic porous plates 101 become complicatedly entangled with each other and substantially integrated.

The electrode mixture 102, that is, a positive electrode mixture, in a case where the secondary battery electrode 100 is used as a positive electrode mainly contains a positive electrode active material, and sometimes further contains a solid electrolyte, a binder, and a conductive assistant as necessary. In addition, the electrode mixture 102, that is, a negative electrode mixture, in a case where the secondary battery electrode 100 is used as a negative electrode mainly contains a negative electrode active material, and sometimes further contains a solid electrolyte, a binder, and a conductive assistant as necessary.

As materials of a positive electrode active material, it is possible to use well-known materials, for example, complex oxides, such as lithium cobaltate (LiCoO₂), lithium nickelate (LiNiO₂), lithium manganate (LiMnO₂), lithium manganese spinel (LiMn₂O₄), and olivine type lithium phosphorus oxide (LiFePO₄), which contain lithium and a transition metal; conductive polymers such as polyaniline and polypyrrole; sulfides such as Li₂S, CuS, Li—Cu—S compounds, TiS₂, FeS, MoS₂, and Li—Mo—S compounds; and a mixture of sulfur and carbon.

The above-described materials of the positive electrode active material may be used singly or in combination of two or more thereof.

As materials of a negative electrode active material, it is possible to use well-known materials, for example, metallic elements such as indium, aluminum, silicon, tin, and lithium, and alloys thereof, inorganic oxides (for example, Li₄Ti₅O₁₂), carbon-based active materials (for example, mesocarbon microbeads (MCMB), highly oriented graphite (HOPG), hard carbon, and soft carbon), and conductive polymers such as polyacene, polyacetylene, and polypyrrole. The above-described materials of the negative electrode active material may be used singly or in combination of two or more thereof.

A solid electrolyte that can conduct lithium ions may be used, and at least one selected from the group consisting of, for example, perovskite-type compounds such as La_{0.51}Li_{0.34}TiO_{2.94} and La_{0.5}Li_{0.5}TiO₃, LISICON-type compounds such as Li₁₄Zn(GeO₄)₄, garnet-type compounds such as Li₇La₃Zr₂O₁₂, Nasicon-type compounds such as Li_{1.3}Al_{0.3}Ti_{1.7}(PO₄)₃ or Li_{1.5}Al_{0.5}Ge_{1.5}(PO₄)₃, thio-LISICON-type compounds such as Li_{3.25}Ge_{0.25}P_{0.75}S₄ or Li₃PS₄, glass compounds such as 50Li₄SiO₄.50Li₃BO₃, Li₂S—P₂S₅, or Li₂O—Li₃O₅—SiO₂, phosphate compounds such as Li₃PO₄, Li_{3.5}Si_{0.5}P_{0.5}O₄, or Li_{2.9}PO_{3.3}N_{0.46}, amorphous compounds such as Li_{2.9}PO_{3.3}N_{0.46} (LIPON) or Li_{3.6}Si_{0.6}P_{0.4}O₄, glass ceramics such as Li_{1.07}Al_{0.69}Ti_{1.46}(PO₄)₃ or Li_{1.5}Al_{0.5}Ge_{1.5}(PO₄)₃, inorganic solid electrolytes such as lithium-containing salts, polymer-based solid electrolytes such as polyethylene oxide, and gel-based solid electrolytes containing lithium-containing salts or a lithium ion conductive ionic liquid can be used.

Fluororesins such as polyvinylidene fluoride (PVDF), polytetrafluoroethylene (PTFE), a tetrafluoroethylene-hexafluoropropylene copolymer (FEP), a tetrafluoroethylene-perfluoroalkyl vinyl ether copolymer (PFA), an ethylene-tetrafluoroethylene copolymer (ETFE), polychlorotrifluoroethylene (PCTFE), an ethylene-chlorotrifluoroethylene copolymer (ECTFE), and polyvinyl fluoride (PVF), an acrylic acid polymer, a cellulose polymer, a styrene polymer, a styrene-butadiene copolymer, a vinyl acetate polymer, or a urethane polymer can be used as a binder. The above-described materials of the binder may be used singly or in combination of two or more thereof.

Carbon powder such as carbon black, fine metal powder such as carbon nanotubes, carbon materials, copper, nickel, stainless steel, and iron, a mixture of carbon materials and fine metal powder, and conductive oxides such as ITO can be used as a conductive assistant. The above-described materials of the conductive assistant may be used singly or in combination of two or more thereof.

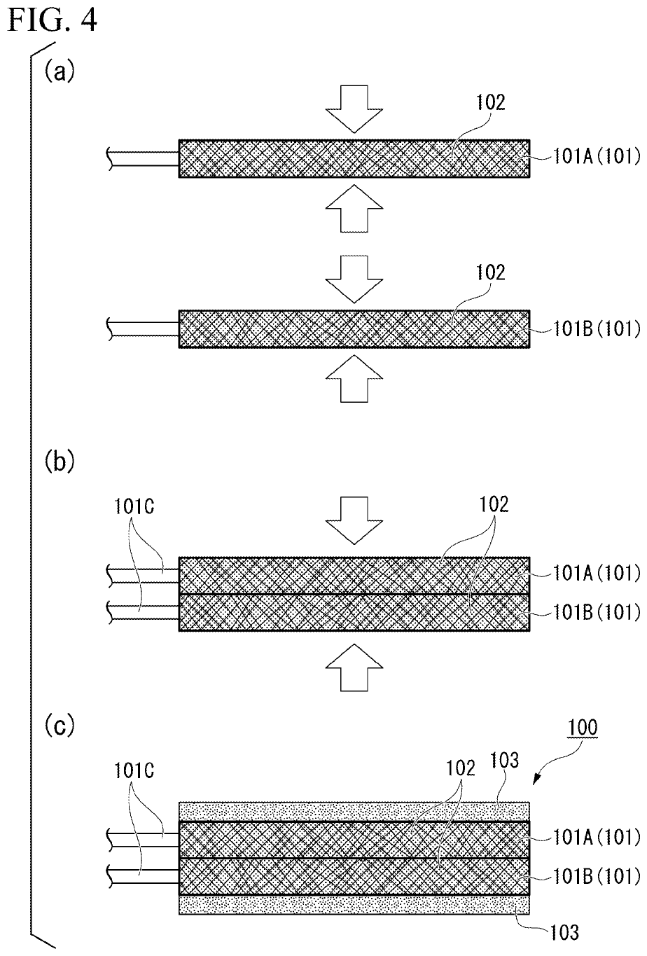

FIG. 3 is a view showing a modification example of the secondary battery electrode 100 of FIG. 1A. As described above, protruding end portions 101c are provided on the surface of the metallic porous plate 101. In a case where an electrolyte layer is formed immediately above the end portions, the end portions 101c are likely to come into contact with the electrolyte layer, and there is a concern that a short circuit may be caused when the secondary battery electrode 100 is made to act as a secondary battery electrode. The end portions 101c on the exposed surface of the metallic porous plate 101 are preferably covered with a short-circuit prevention film (protective film) 103 as shown in FIG. 3. The exposed surface of the metallic porous plate 101 here sometimes includes a side surface in addition to the main surface. The thickness of the short-circuit prevention film 103 is preferably about 0.01 to 0.10 μm. As the short-circuit prevention film 103, a separator or the like is used in a case where the electrolyte is a liquid, and a solid electrolyte is used in a case where the electrolyte is a solid. In the secondary battery electrode, a protective film formed on a positive electrode side is preferably made of a substance containing at least one of a positive electrode active material and a solid electrolyte. In addition, in the secondary battery electrode, a protective film formed on a negative electrode side is preferably made of a substance containing at least one of a negative electrode active material and a solid electrolyte.

(a) to (c) of FIG. 4 are cross-sectional views of objects to be treated in a process of manufacturing the secondary battery electrode 100. The secondary battery electrode 100 can be manufactured mainly through the following procedure.

First, a predetermined number of metallic porous plates 101 are prepared, voids thereof are filled (impregnated) with an active material 102. The number of metallic porous plates 101 to be prepared is determined in consideration of the thickness of the secondary battery electrode 100 to be finally obtained. Here, as shown in FIG. 4(a), it is preferable that the plurality of metallic porous plates 101 filled with the active material be individually pressed from both sides in the thickness direction T (arrow direction) before the metallic porous plates are superposed. The uniformity of the filling rate of the electrode mixture in the whole metallic porous plates can be improved by this pressing.

Next, in a case where the plurality of pressed metallic porous plates 101 are pressed in the superposition direction (arrow direction) as shown in FIG. 4(b) in a state of being superposed in the thickness direction T, the plurality of superposed metallic porous plates 101 can be press-joined to each other, and the secondary battery electrode 100 can be obtained. By this pressing, the protruding end portions 101c constituting the joining surfaces of the metallic porous plates 101 are complicatedly entangled with each other and substantially integrated as described above. The strength of the pressing is preferably adjusted so that the final thickness of the secondary battery electrode 100 becomes about 40 to 2,000 μm.

The protruding end portions 101c are exposed in metallic porous plates positioned at both ends (an upper end and a lower end in FIG. 4) in the superposition direction among the plurality of press-joined metallic porous plates 101. For this reason, it is preferable that short-circuit prevention films 103 that cover the end portions 101c be further formed as shown in FIG. 4(c).

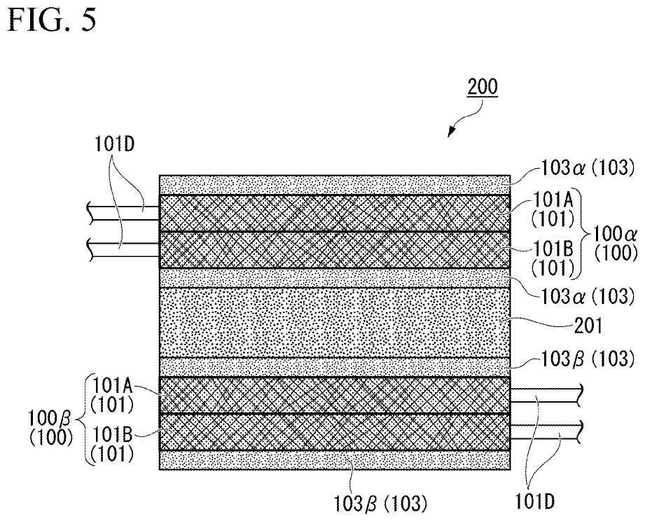

FIG. 5 is a cross-sectional view of a secondary battery 200 that can be formed using the secondary battery electrode 100 of the present embodiment. The secondary battery 200 includes a positive electrode 100α manufactured using a positive electrode mixture and a negative electrode 100β manufactured using a negative electrode mixture as the secondary battery electrodes 100, and an electrolyte 201 sandwiched therebetween. The surfaces of the positive electrode 100α and the negative electrode 100β are respectively covered with short-circuit prevention films 103α and 103β. The short-circuit prevention films of both electrodes are superposed to face each other through the electrolyte 201.

An anion-conductive material or a cation-conductive material may be used as the material of the electrolyte 201 as long as the material has low electron conductivity and high lithium ion conductivity. The electrolyte 201 of the present embodiment may be a solid or a liquid.

As a solid electrolyte at least one selected from the group consisting of perovskite-type compounds such as La_{0.51}Li_{0.34}TiO_{2.94} and La_{0.5}Li_{0.5}TiO₃, LISICON-type compounds such as Li₁₄Zn(GeO₄)₄, garnet-type compounds such as Li₇La₃Zr₂O₁₂, Nasicon-type compounds such as Li_{1.3}Al_{0.3}Ti_{1.7}(PO₄)₃ or Li_{1.5}Al_{0.5}Ge_{1.5}(PO₄)₃, thio-LISICON-type compounds such as Li_{3.25}Ge_{0.25}P_{0.75}S₄ or Li₃PS₄, glass compounds such as 50Li₄SiO₄.50Li₃BO₃, Li₂S—P₂S₅, or Li₂O—Li₃O₅—SiO₂, phosphate compounds such as Li₃PO₄, Li_{3.5}Si_{0.5}P_{0.5}O₄, or Li_{2.9}PO_{3.3}N_{0.46}, amorphous compounds such as Li_{2.9}PO_{3.3}N_{0.46} (LIPON) or Li_{3.6}Si_{0.6}P_{0.4}O₄, glass ceramics such as Li_{1.07}Al_{0.69}Ti_{1.46}(PO₄)₃ or Li_{1.5}Al_{0.5}Ge_{1.5}(PO₄)₃, inorganic solid electrolytes such as lithium-containing salts, polymer-based solid electrolytes such as polyethylene oxide, and gel-based solid electrolytes containing lithium-containing salts or a lithium ion conductive ionic liquid can be used.

As a liquid electrolyte (non-aqueous electrolyte), it is possible to use: a salt which contains a cation and an anion and in which the cation is, for example, lithium, quaternary ammonium such as tetraethylammonium, triethylmethylammonium, spiro-(1,1′)-bipyrrolidinium, or diethylmethyl-2-methoxyethylammonium (DEME), and imidazolium such as 1,3-dialkylimidazolium, 1,2,3-trialkylimidazolium, 1-ethyl-3-methylimidazolium (EMI), or 1,2-dimethyl-3-propylimidazolium (DMPI), and the anion is, for example, BF₄⁻, PF₆⁻, CIO₄⁻, AICI₄⁻, or CF₃SO₃⁻; or an ionic liquid such as LiTFSi.

Examples of these solvents include organic solvents such as propylene carbonate (PC), ethylene carbonate (EC), dimethyl carbonate (DMC), diethyl carbonate (DEC), acetonitrile (AN), propionitrile, γ-butyrolactone (BL), dimethylformamide (DMF), tetrahydrofuran (THF), dimethoxyethane (DME), dimethoxymethane (DMM), sulfolane (SL), dimethyl sulfoxide (DMSO), ethylene glycol, propylene glycol, and methyl cellosolve.

These may be used singly or in combination of two or more thereof at an arbitrary ratio.

In the secondary battery electrode 100 according to the present embodiment, the electrode mixture 102 is formed in a state in which holes constituting a metallic porous plate are filled with the electrode mixture, and is supported by inner walls of the holes to maintain the strength. For this reason, even in the case where metallic porous plates 101 are superposed to form an electrode mixture thick, it is unnecessary to increase the content of binder to maintain the strength, and increase in electrical resistance due to the binder can be suppressed.

In addition, in the case where the metallic porous plates 101 are superposed, current-collecting units are spread and distributed in a thickness direction of the electrode mixture. Therefore, even in the case where a thick electrode mixture is formed, a portion of the electrode mixture 102 where the distances from the current-collecting units become longer can be reduced. Therefore, increase in electrical resistance depending on the distances can be suppressed.

Accordingly, according to the secondary battery electrode 100 of the present embodiment, by forming the thick electrode mixture 102, it is possible to increase the energy density and avoid the problem of decrease in output in a case where the secondary battery electrode of the present embodiment is applied to a secondary battery which includes the secondary battery electrode as a positive electrode and a negative electrode and a stacked body obtained by stacking the positive electrode, an electrolyte layer or a separator layer, and the negative electrode in this order.

In the secondary battery electrode 100 of the present embodiment, the plurality of thin metallic porous plates 101 individually filled with the electrode mixture 102 are superposed. That is, since the filling using the electrode mixture 102 is performed individually for each of the thin metallic porous plates 101, the filling volume is limited to a narrow range, and the variation in the filling rate can be suppressed. More specifically, the standard deviation of the filling rate of the electrode mixture 102 is suppressed to 10% or less in a direction (direction substantially perpendicular to the thickness direction T) parallel to the main surfaces of the metallic porous plates 101, and an approximately uniform filling state can be obtained. In a case where an integrated thick metallic porous plate 101, which has the same thickness as that in the case where an electrode includes a plurality of metallic porous plates, is filled with the electrode mixture 102, it is difficult to suppress the variation in the filling rate to the same level as that in this case.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

100 Secondary battery electrode
100α Positive electrode
100β Negative electrode
101, 101A, 101B Metallic porous plate
101c End portion
101D Electrode lead-out portion
101S Void
102 Electrode mixture
102a Surface of electrode mixture
103, 103α, 103β Short-circuit prevention film (protective film)
200 Secondary battery
201 Electrolyte

What is claimed is:

1. A secondary battery electrode comprising:
a plurality of metallic porous plates superposed in a thickness direction; and
an electrode mixture with which voids constituting the metallic porous plates are filled,
wherein adjacent metallic porous plates are press-joined to each other.

2. The secondary battery electrode according to claim 1,
wherein a porosity of the electrode mixture used for filling is less than or equal to 5%.

3. The secondary battery electrode according to claim 1,
wherein the metallic porous plates are of a foamed metal.

4. The secondary battery electrode according to claim 2,
wherein the metallic porous plates are of a foamed metal.

5. The secondary battery electrode according to claim 1,
wherein end portions protruding outward from a surface of the electrode mixture used for filling are provided on a surface of the metallic porous plate.

6. The secondary battery electrode according to claim 2,
wherein end portions protruding outward from a surface of the electrode mixture used for filling are provided on a surface of the metallic porous plate.

7. The secondary battery electrode according to claim 1,
wherein a protective film is formed at both ends in the direction in which the plurality of metallic porous plates are superposed.

8. The secondary battery electrode according to claim 2,
wherein a protective film is formed at both ends in the direction in which the plurality of metallic porous plates are superposed.

9. The secondary battery electrode according to claim 1,
wherein the protective film on a positive electrode side is made of a substance containing at least one of a positive electrode active material and a solid electrolyte.

10. The secondary battery electrode according to claim 2,
wherein the protective film on a positive electrode side is made of a substance containing at least one of a positive electrode active material and a solid electrolyte.

11. The secondary battery electrode according to claim 1,
wherein the protective film on a negative electrode side is made of a substance containing at least one of a negative electrode active material and a solid electrolyte.

12. The secondary battery electrode according to claim 2,
wherein the protective film on a negative electrode side is made of a substance containing at least one of a negative electrode active material and a solid electrolyte.

13. The secondary battery electrode according to claim 1,
wherein a standard deviation of a filling rate of the electrode mixture in a direction parallel to a main surface of the metallic porous plate is less than or equal to 10%.

14. The secondary battery electrode according to claim 2,
wherein a standard deviation of a filling rate of the electrode mixture in a direction parallel to a main surface of the metallic porous plate is less than or equal to 10%.

15. A method for manufacturing the secondary battery electrode according to claim 1, the method comprising:
a step of filling voids of a plurality of metallic porous plates with an electrode mixture; and
a step of pressing the plurality of metallic porous plates in a superposition direction in a state where the plurality of metallic porous plates are superposed in a thickness direction.

16. A method for manufacturing the secondary battery electrode according to claim 2, the method comprising:
a step of filling voids of a plurality of metallic porous plates with an electrode mixture; and
a step of pressing the plurality of metallic porous plates in a superposition direction in a state where the plurality of metallic porous plates are superposed in a thickness direction.

17. The method for manufacturing the secondary battery electrode according to claim 15, the method further comprising:
a step of individually pressing the plurality of metallic porous plates filled with the electrode mixture in the thickness direction before the metallic porous plates are superposed.

18. The method for manufacturing the secondary battery electrode according to claim 16, the method further comprising:
a step of individually pressing the plurality of metallic porous plates filled with the electrode mixture in the thickness direction before the metallic porous plates are superposed.

19. A secondary battery comprising:
the secondary battery electrode according to claim 1 as a positive electrode and a negative electrode; and
a stacked body obtained by stacking the positive electrode, an electrolyte layer or a separator layer, and the negative electrode in this order.

20. A secondary battery comprising:
the secondary battery electrode according to claim 2 as a positive electrode and a negative electrode; and
a stacked body obtained by stacking the positive electrode, an electrolyte layer or a separator layer, and the negative electrode in this order.
